(19) United States
(12) Patent Application Publication
(10) Pub. No.: US 2014/0295370 A1
(43) Pub. Date: Oct. 2, 2014

(54) MEDICAL IRRIGATION DEVICE

(71) Applicants: Marc Balson, Livingston, NJ (US); Joseph S. Dovgan, Phoenix, AZ (US)

(72) Inventors: Marc Balson, Livingston, NJ (US); Joseph S. Dovgan, Phoenix, AZ (US)

(21) Appl. No.: 14/351,384

(22) PCT Filed: Jul. 20, 2012
(86) PCT No.: PCT/US12/47595

§ 371 Date: Apr. 11, 2014

Related U.S. Application Data
(60) Provisional application No. 61/509,619, filed on Jul. 20, 2011.

(51) Int. Cl. A61C 5/02; A61C 17/02

(52) U.S. Cl. CPC A61C 5/02; A61C 17/0208
USPC 433/29; 433/32; 433/224

(57) ABSTRACT

A device for treating a root canal in a tooth including a fixture piece having a lumen and a distal tip, a first electrode in communication with the lumen, and a sonic or ultrasonic energy source. The first electrode is configured to deliver electrical energy to an irrigating fluid passing through the lumen prior to discharge from the distal tip. Sonic or ultrasonic energy source is provided from the fixture piece for delivery of sonic or ultrasonic energy to the root canal. A fluid supply line or replaceable cartridge can be provided to delivery irrigating fluid to the fixture piece. A method for treatment of a root canal and kit assembly are further provided.

### FIELD OF THE INVENTION

The present invention relates to a method and device for treatment of a root canal and, more particularly, but not exclusively to a method and device for medical irrigation of a root canal using electrically charged fluid.

### BACKGROUND OF THE INVENTION

A root canal includes main or primary canals within the dentin of a tooth. They are typically filled with a highly vascularized loose connective tissue referred to as dental pulp. This pulp commonly becomes infected or inflamed and must be removed to prevent additional degradation of the tooth and surrounding structures that could result in its loss. The procedure of removing the pulpal tissue from the root canal is also commonly referred to as a root canal.

A root canal procedure includes accessing the pulp via the top (crown) of the tooth to gain access to the root canal or pulp chamber. The easily accessible pulp is removed. Next, one or more endodontic instruments are utilized to remove additional pulpal and the tooth's pulpal remnants from inside the primary canals as well as smooth and clean the side surfaces of the canals to remove the biofilm.

Due to the fact that the dentin surrounding the main canals is highly porous from dentinal tubules and endodontic instruments are not suitable for negotiating tortuous canals. There are many locations where pulpal tissue and other debris remain after instrumentation, a tissue dissolving biocide solution is typically used between filing operations and after the filing operations are completed to not only flush out bacteria and their toxins, necrotic debris and tissue, dead tissue and debris but also kill any remaining bacteria or biofilm retained in the tributary canals and dentinal tubules. Using known procedures it is difficult and time consuming to fully dissolve all bacteria located within the dentinal tubules, lateral canals, and uninstrument areas, and as such multiple sessions may be required to complete the procedure. After the infection has been eradicated, the root canal is filled and the top of the tooth is sealed with a permanent filling or a crown.

Due to the difficulties in accessing and cleaning the extraordinarily small passageways of the canal, infection and reinfection can occur. Thus, there is a need for an improved apparatus, system and methodology for treatment of root canals.

### SUMMARY OF THE INVENTION

The present invention fulfills this need by providing an improved apparatus, system and methodology for treating root canals more effectively and efficiently.

In one aspect of the invention, a device or apparatus is provided for treating a root canal in a tooth including a fixture piece, a first electrode and a sonic or ultrasonic energy source. The fixture piece includes a lumen and a distal tip. The lumen includes a proximal end extending from the fixture piece and a distal end extending from the distal tip. The distal tip is configured to deliver electrically charged irrigating fluid at or near the apex of the root canal. The first electrode is configured to be in communication with the proximal end of the lumen and to deliver electrical energy to an irrigating fluid passing through the proximal end prior to discharge of the irrigating fluid from the distal tip. The sonic or ultrasonic energy source of the fixture piece provides for delivery of sonic or ultrasonic energy to the root canal and more particularly at or near the apex of the canal. The electrical energy accelerates the tissue dissolution process and imparts an electromotive force to the irrigating fluid.

Further, the present invention includes a device or apparatus for treating a root canal in a tooth, the device including a fixture piece having a chamber for receiving a replaceable cartridge, a first electrode, a second electrode, a sonic or ultrasonic energy source, a replaceable cartridge and a plunger system. The fixture piece includes a lumen and a distal tip. The lumen includes a proximal end extending from the fixture piece and a distal end extending from the distal tip. The distal tip is configured to deliver electrically charged irrigating fluid at or near the apex of the root canal. The first electrode is in communication with the proximal end of the lumen. The first electrode is configured to deliver electrical energy to an irrigating fluid passing through the proximal end prior to discharge of the irrigating fluid from the distal tip. The second electrode may be exterior to the tooth or, if not, a measurable distance from the distal tip to complete the electric field. The sonic or ultrasonic energy source from the fixture piece delivers sonic or ultrasonic energy to the root canal and more particularly at or near the apex of the canal. The replaceable cartridge of irrigating fluid is within the chamber and the cartridge is in fluid communication with the lumen to supply irrigating fluid thereto. The plunger system is integrated with the fixture piece and configured to mechanically force the irrigating fluid out of the replaceable cartridge into the lumen.

Additionally, the present invention provides a kit assembly for treating a root canal in a tooth. The kit includes a fixture piece, at least one replaceable portion, and at least one replaceable cartridge(s). The fixture piece includes a chamber, a lumen connector and a sonic or ultrasonic energy source for delivery of sonic or ultrasonic energy to the root canal. The replaceable portion includes a lumen, a distal tip and a first electrode. The lumen has a proximal end and a distal end. The proximal end of the lumen is removably attached to the lumen connector of the fixture piece. This permits assembly and disassembly, as well as potentially allowing for disposable parts. The entire replaceable portion or a portion of the replaceable portion may be disposable, i.e., intended for single use. The distal tip extends from the distal end of the lumen. The distal tip is configured to deliver electrically charged irrigating fluid at or near the apex of the root canal. The first electrode is in communication with the lumen about the proximal end. The first electrode is configured to deliver electrical energy to an irrigating fluid passing through the proximal end prior to discharge of the irrigating fluid from the distal tip. The replaceable cartridge of irrigating fluid is configured to be inserted into the chamber to supply irrigating fluid to the lumen. The cartridge may be disposed of after use and replaced with a fresh cartridge of irrigating fluid.

Furthermore, the present invention provides a method for treatment of a root canal in a tooth. The method includes the steps of providing a fixture piece having a sonic energy source, a lumen and a distal tip, the lumen has a proximal end extending from the fixture piece to a distal end extending from the distal tip, the distal tip is configured to deliver electrically charged irrigating fluid at or near the apex of the root canal, the sonic energy source operative to introduce sonic energy to the root canal; inserting the distal tip of the lumen into the root canal; and delivering the electrical energy, sonic energy and electrically charged irrigating fluid at or near apex of the root canal.

In another aspect of the invention, there is provided a method of treating a root canal which includes delivering sonic energy, electrical energy and electrically charged irrigating fluids to, near or substantially at the apex of the root canal. Desirably, the method includes one or more of the apparatus, system or kit embodiments described herein.

### BRIEF DESCRIPTION OF THE DRAWINGS

FIG. 1 is a side view of a fixture piece of the irrigation device of the present invention.

FIG. 2 is a side view of a fixture piece of FIG. 1 attached to a hand piece.

FIG. 3A is a perspective side view of another embodiment of the device of the present invention including a regulator in the irrigating fluid supply line. FIG. 3B is an enlarged perspective side view of the distal tip having multiple portals at both the distal tip and proximal end.

FIG. 4 is an exploded view of a light element of the fixture piece of the present invention.

FIG. 5 is a side view of an integrated fixture hand piece of the present invention including a fixture piece with a chamber to receive replaceable cartridges of irrigating fluid therein.

FIG. 6 is a side view of the device of FIG. 5 including an apex locator and a vacuum line.

FIGS. 7-22 are various views and information of the present invention.

### DETAILED DESCRIPTION OF THE INVENTION

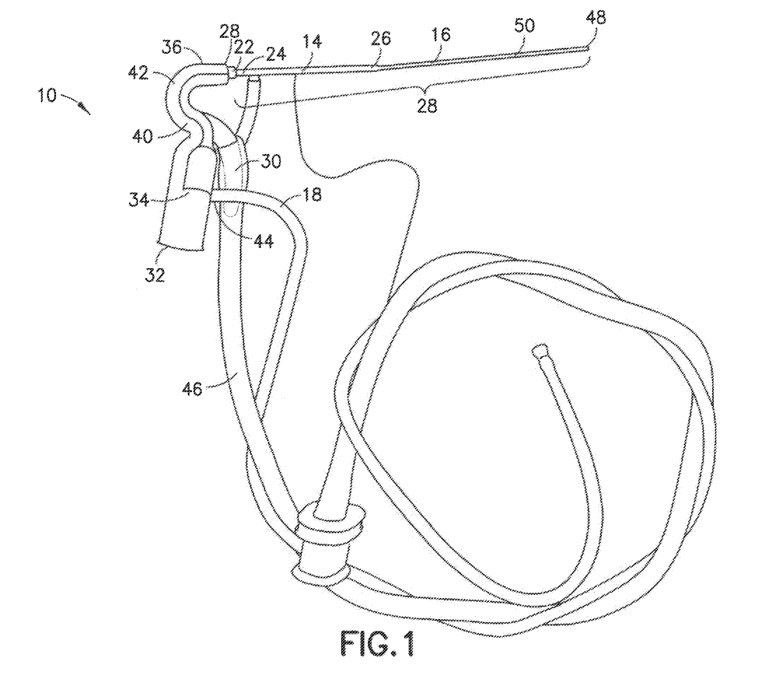

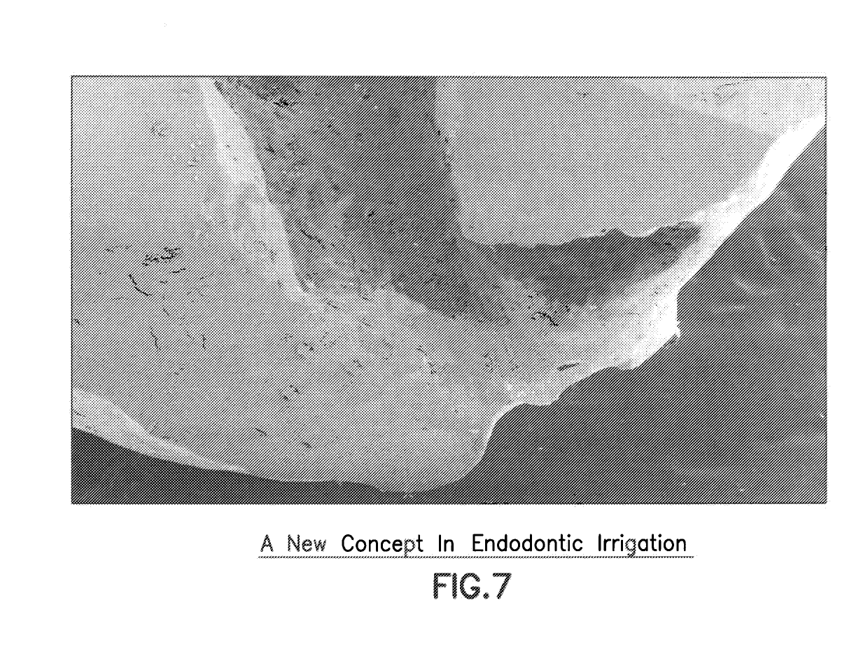

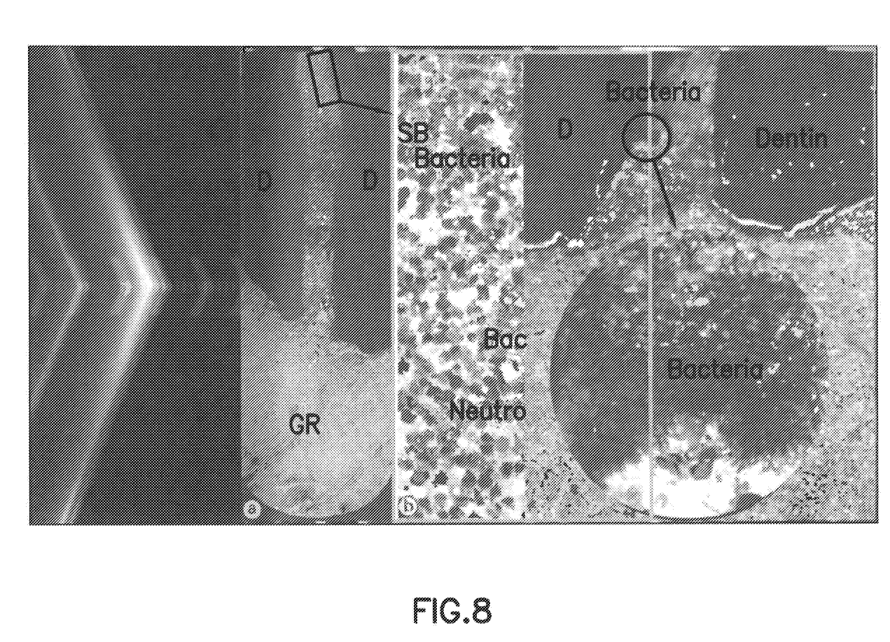

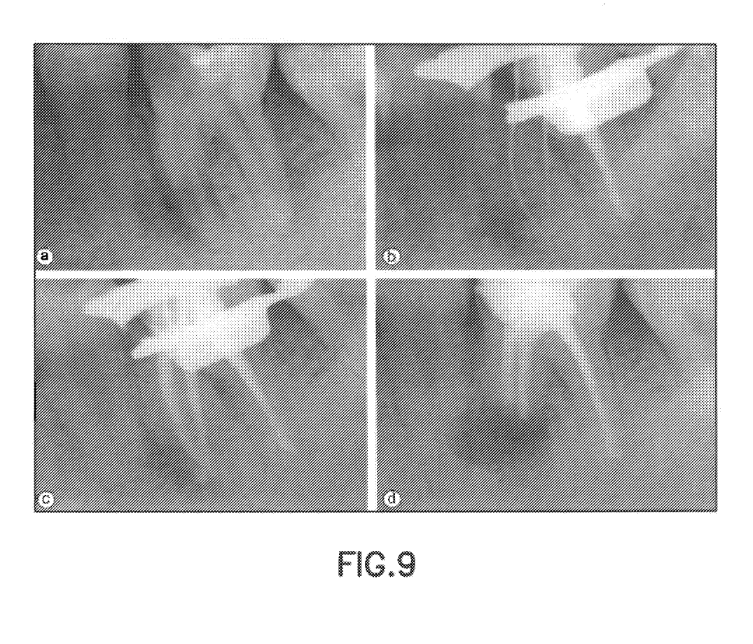

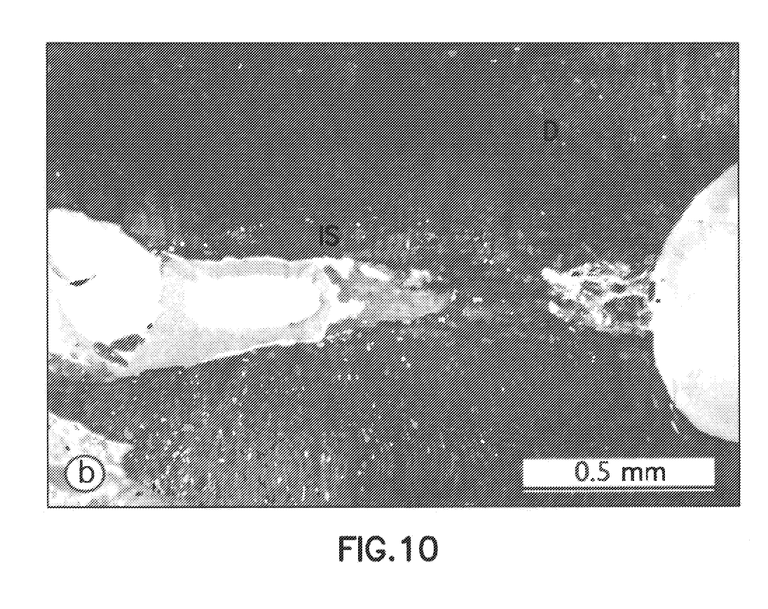

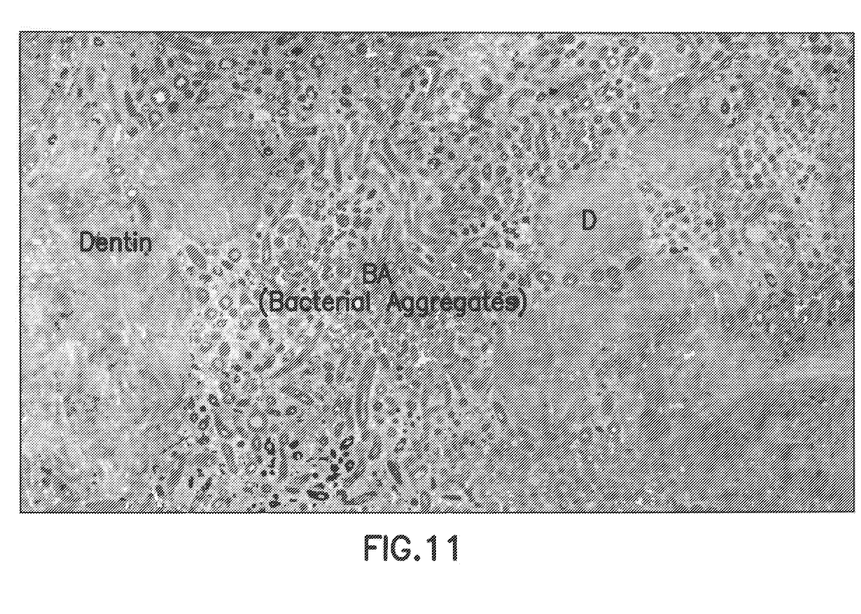

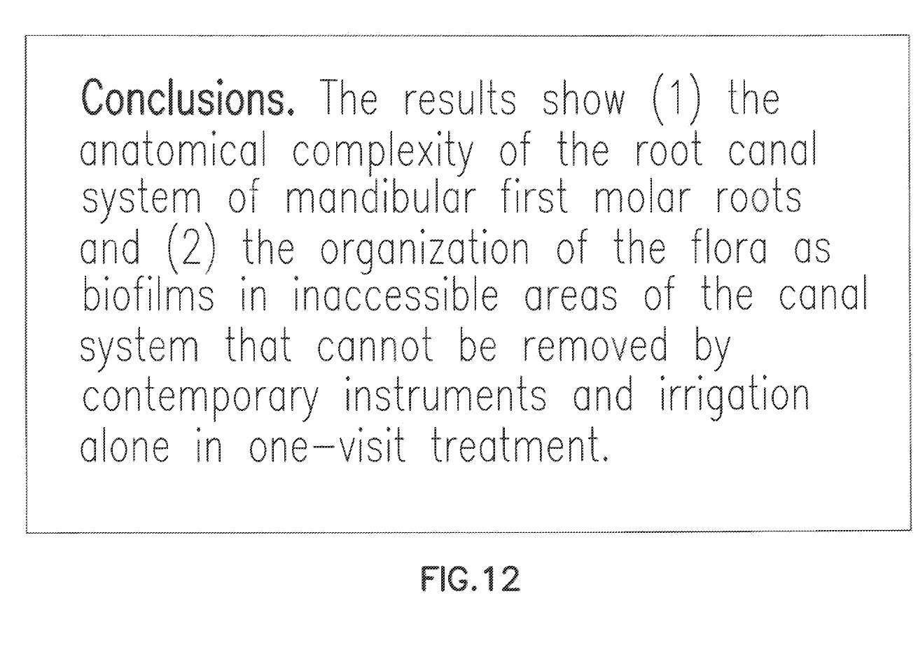

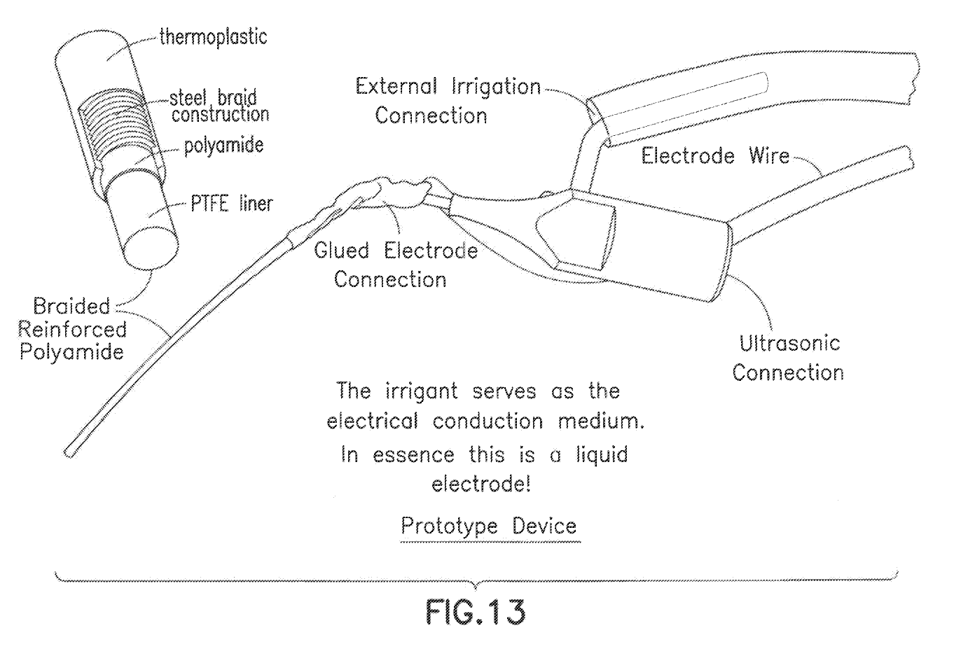

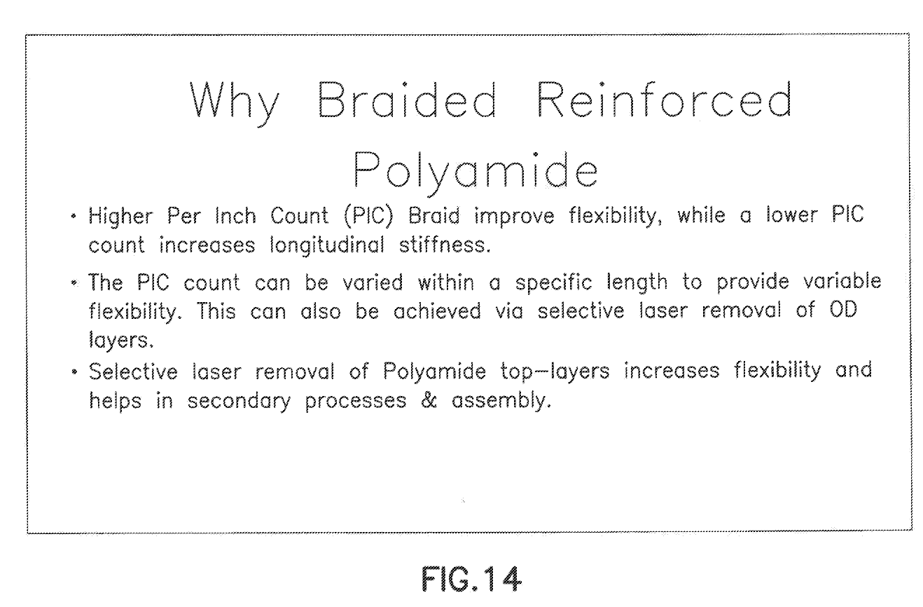

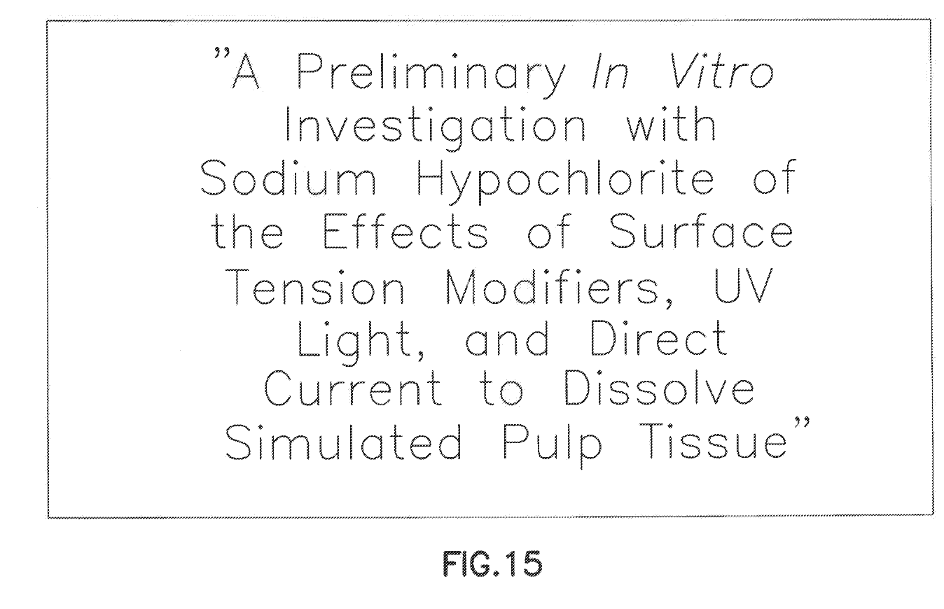

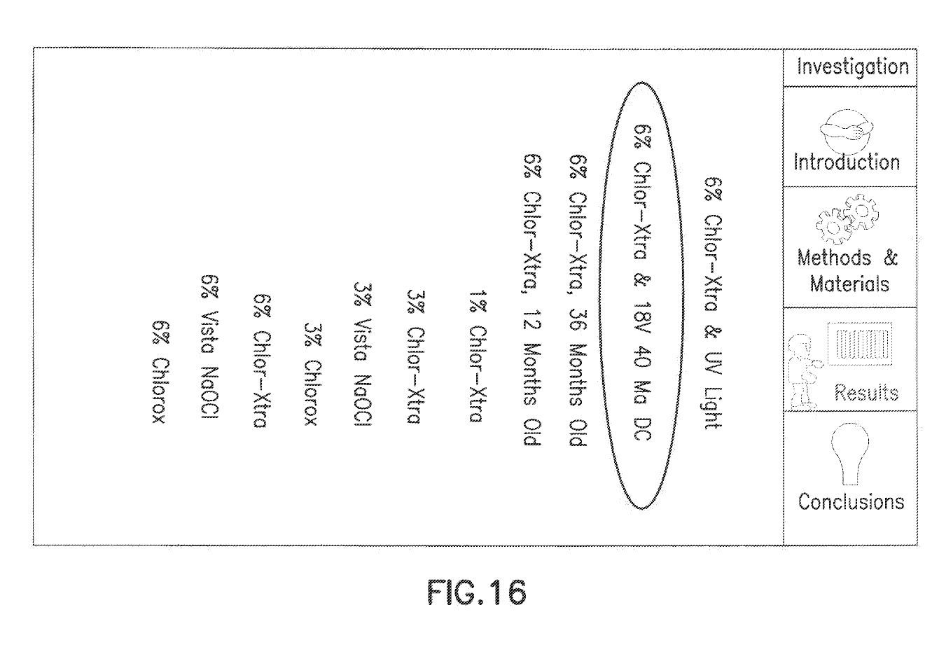

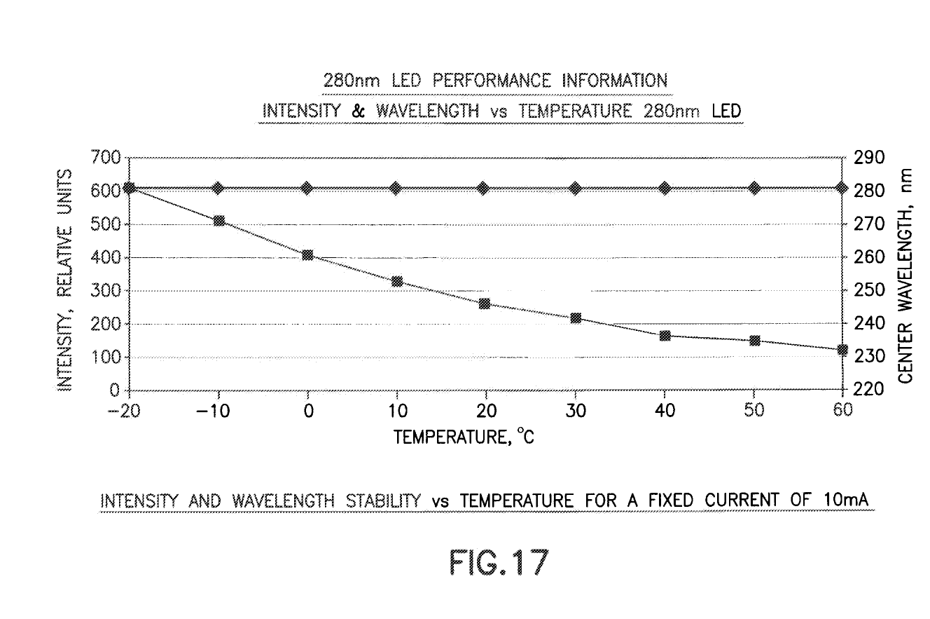

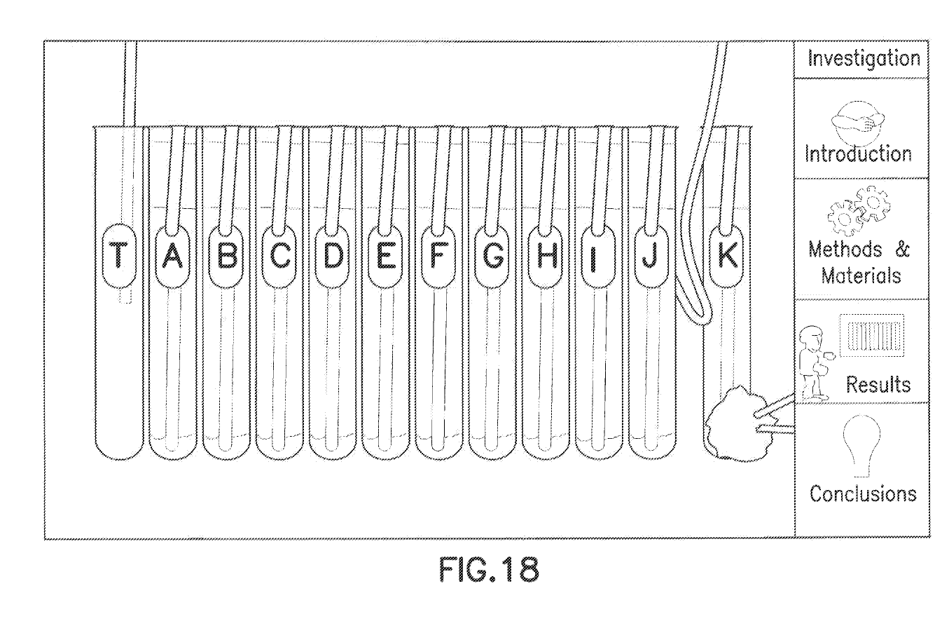

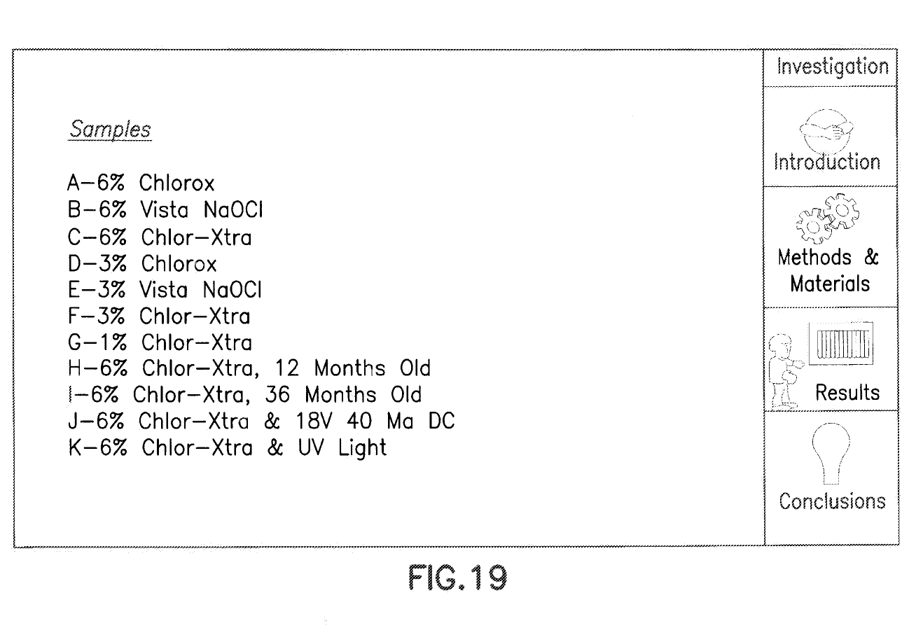

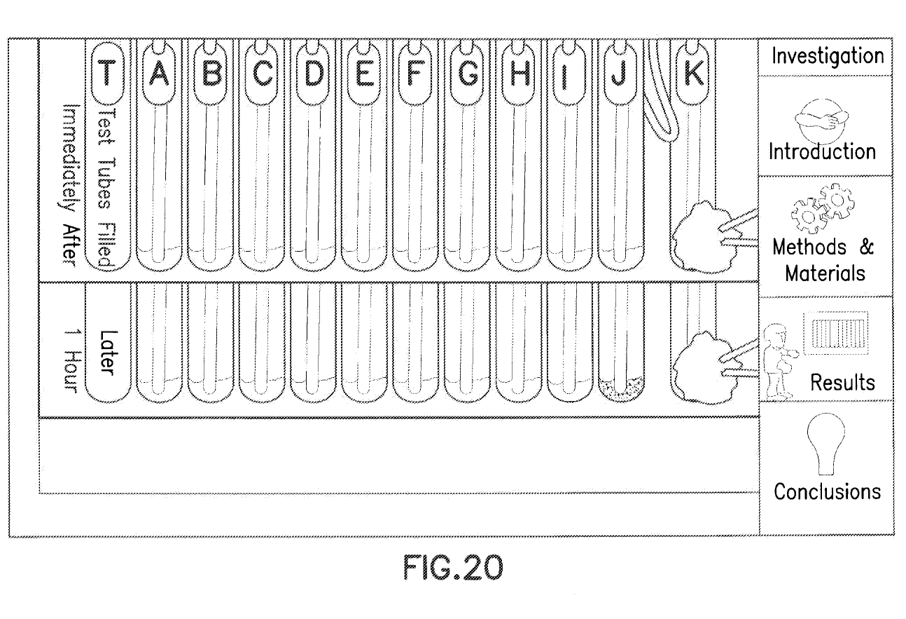

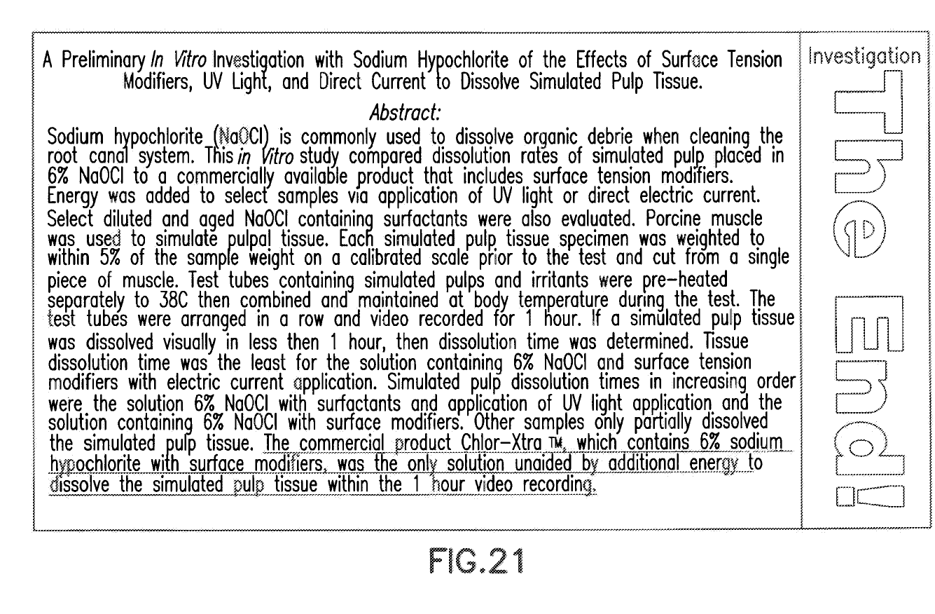

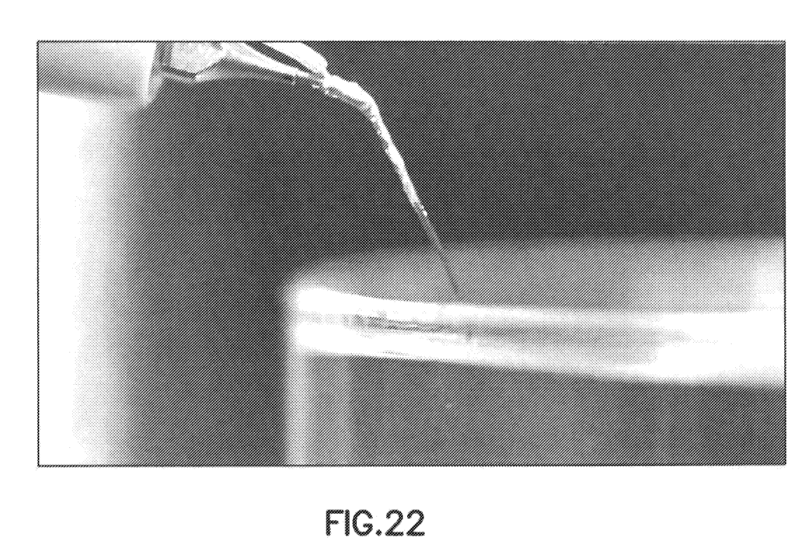

FIGS. 1-22 are incorporated herein.

FIGS. 1-6 show various embodiments of a medical irrigating device, system and kit of the present invention. The device of one embodiment of the present invention includes a fixture piece, a lumen, a distal tip, a first electrode and a sonic or ultrasonic energy source. The device of the present invention electrically charges irrigating fluid prior to entering to the tooth and delivers the charged irrigating fluid within the root canal at or near the apex. An electrical field is created and delivered within the canal by the delivery of the charged irrigating fluid. The charged irrigating fluid accelerates the dissolving of necrotic tissue which in some cases may need to occur prior to removal of any biofilm present on the canal surface. Due to the anatomy of the tooth, the necrotic tissue generally must be dissolved to access the surface of the pulp canal wherein the biofilm grows and is typically attached thereto. Biofilm is a source of potential infection and desirably is removed during the root canal treatment. Prior techniques have not been very successful in this regard. The present invention of delivering the electrically charged irrigating fluid at or near the apex disturbs the bacteria and accelerates the dissolution by a magnitude of between about 2 to about 5 times the prior art methods of biocide cleaning Additionally, plantonic cells will also be killed, dissolved, or reduced by the charged irrigating fluid. Alternating with other irrigants such as EDTA can alter the matrix of the biofilm removing additional debris and bacteria. Although, dentin tubules which extend from the pulp canal or root canal are too small for biocide fluid to enter, bacteria can still grow and populate the tubules causing latent infection. Additionally, orifices to the dental tubules can be blocked by debris making it difficult for irrigating fluid to penetrate. The present invention uses iontophoresis or the movement of ions through biological material under the influence of an electric current which allows for dissolution of necrotic tissue, biofilm, debris and other materials within the root canal which may cause infection or inflammation over time if not removed. Iontophoresis as used in the present invention also provides an additional benefit of being able to deliver various chemicals and drugs through the tooth and at or near the apex of the canal. The present invention does not require, but may optionally include, a biocide in addition to other components in treating the root canal.

FIG. 1 shows device 10 including fixture piece 12, lumen 14, distal tip 16 and first electrode 18. The fixture piece 12 includes a lumen connector 22, a fluid supply inlet 30, and a hand held connector 32. The proximal end 24 of the lumen 14 is attached to and extends from the fixture piece 12 at the lumen connector 22. Attached to the lumen 14 about the proximal end 24 is a first electrode 18 for electrically charging an irrigating fluid as it flows through the lumen 14. The distal tip 16 is attached to the lumen 14 and extends therefrom. Distal tip 16 is a flexible, microcannula portion to allow for access at or near the apex of a root canal for delivery of electrically charged irrigating fluid thereto.

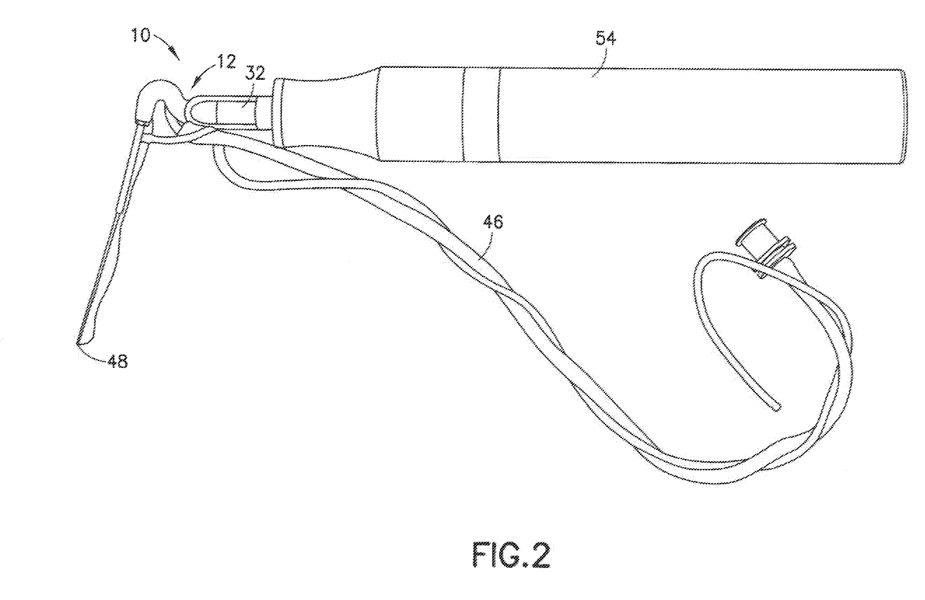

The fixture piece 12 is, in some embodiments, a single continuous molded piece, formed from a formed a metal or substantially rigid polymer such as polypropylene, acrylics, or other polymers or copolymers, or a combination of metal and polymeric materials. The fixture piece 12 includes a handheld connector 32 which includes a straight portion 34 with an outside diameter which narrows down, or in some instances tapers, to a smaller outside diameter. The handheld connector 32 includes divots or other attachment members thereabout for securing the fixture piece 12 to a hand held device 54 or other attachment device. Extending from the handheld connector 32 is a curved portion 36. FIGS. 1-2 show the curved portion 36 as a U-shaped portion. The curved portion 36 includes the lumen connector 22 at one end 38 for attachment of the lumen 14. The other end 40 of the curved portion 36 is a merge point 42 where the handheld connector 32 and the fluid supply inlet 30 merge into the other end 40 of the curved portion 36. The fluid supply inlet 30 is a slightly curved section which is closely aligned and adjacent to the handheld connector 32 to allow for a streamlined device and which helps avoid cumbersome supply lines protruding away from the device, the presence of which would impair or block the vision of the practitioner during use. The space 44 between the handheld connector 32 and the fluid supply inlet 30 is as minimal as possible but large enough to allow for attachment and disengagement of the fluid supply line 46.

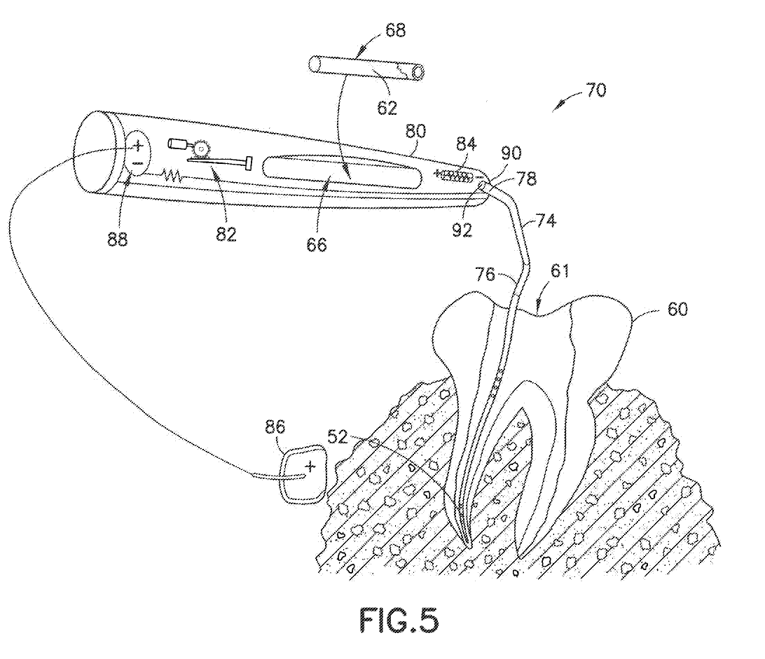

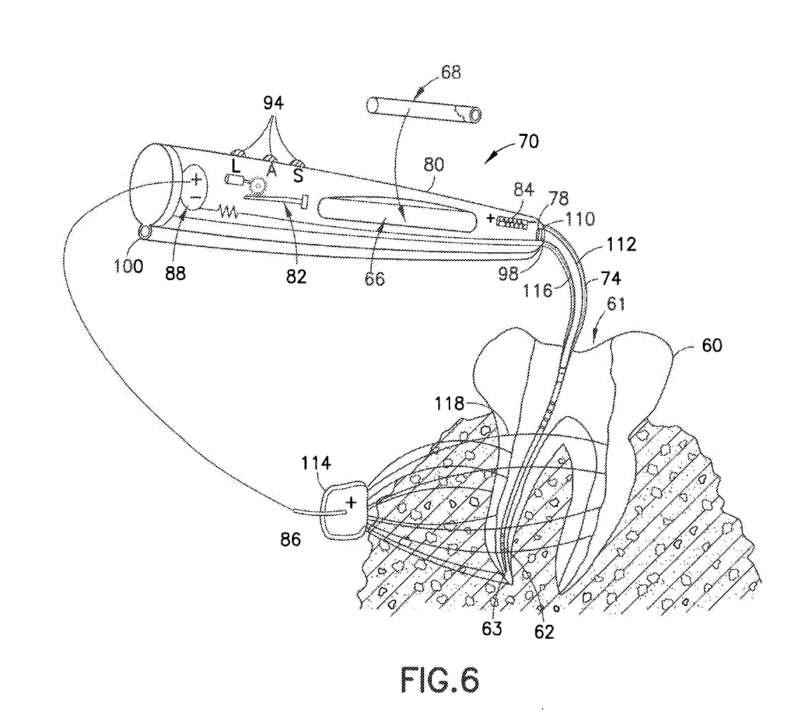

The irrigating fluid can be supplied to the fixture piece using a variety of sources as shown in the Figures. FIGS. 1-3 show the irrigating fluid 62 supplied by the fluid supply line 46. FIGS. 5 and 6 show the irrigating fluid 62 supplied by a replaceable cartridge 68. The irrigating fluid 62 includes a biocompatible fluid that may be electrically conductive. The irrigating fluid may also incorporate a large number of useful components such as antiseptic agents, one or more surfactants, disinfectants, drugs, cleaning agents, biocide agents, bactericides, fungicides and combinations thereof. In one particularly desirable embodiment, surfactants may be incorporated into the fluid. For example, Tritan-X® series, i.e., C₁₄H₂₂O(C₂H₄O)ₙ, by Dow Chemical Company® is a particularly useful surfactant in the present invention.

Irrigating fluids include but are not limited to oxidative potential water anolyte and/or catholyte, EDTA, citric acid, hydrogen peroxide, periacitic acid, alcohol, NaOCl and combinations thereof, and other known irrigating fluids and agents used for root canal cleaning and disinfecting. Further, the device can be used to infuse drugs, obturation materials and other elements into the tooth from within the root canal.

The lumen 14 which transports the irrigating fluid to the distal tip 16 is formed from a conductive material. A metallic tube or a composite, i.e., polymeric, with a conductive portion may be used. The lumen 14 can be formed from multiple layers of material including non-conductive and conductive layers which can include a knit layer, a weave layer, a braid layer, a coating layer, an extruded layer, a ring layer or other structural configuration layers and combinations thereof. For example, the lumen can be formed from 3-layers defining the structural wall. The conductive portion can be incorporated into the structural wall of the lumen 14 in the form of a knit, weave, braid, ring or other structural configuration, which may provide both structural support and conductive properties. The material of the lumen 14 must be capable of transferring the electrical charge from the first electrode to the irrigating fluid as the fluid flows through the lumen 14 and past the first electrode connection. The lumen 14 is sufficiently rigid enough to provide support to the flexible distal tip 16. The shape of the lumen 14 may vary depending on the particular application to allow for accurate control of the delivery of the irrigating fluid to the target site. FIG. 1 shows lumen 14 as having a straight configuration, but it is contemplated that the lumen may be curved, bent or any portion the lumen may be bent, curved, straight or a combination thereof. Additionally, the lumen can include multiple channels therein defining a multi-lumen to transport various materials and/or perform various functions.

It is contemplated that the lumen 14 may be removable attached or permanently fixed to the fixture piece 12. FIG. 1 shows a removable attached lumen 14 from the fixture piece 12 at the lumen connector 22 to allow for replacement of the lumen-replaceable-portion 28. The lumen-replaceable-portion 28 includes lumen 14, distal tip 16 and first electrode 18. After use of the lumen-replaceable-portion 28, it may be removed at the lumen connector 22 and disposed of, or sterilized and re-used if desired. Most desirably, the lumen-replaceable-portion 28 is designed to be used once and disposed of thereafter. A new sterilized lumen-replaceable-portion 28 may be attached which avoids the need to clean and sterilize the lumen-replaceable-portion 28 after each use.

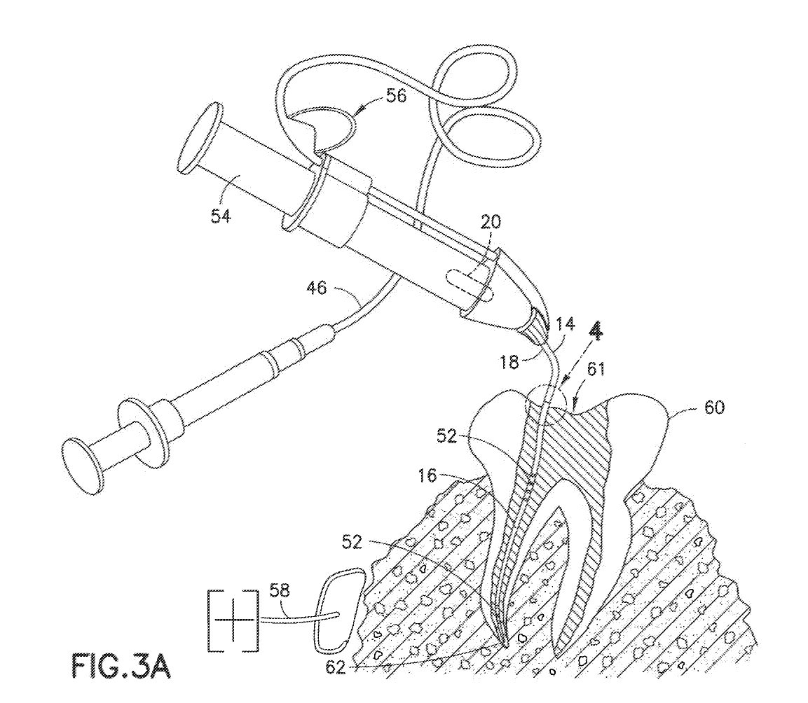

The distal tip 16 is flexible but sufficiently rigid to be manipulated at or near a terminus of an apex of the root canal. The distal tip 16 is a microcannula having formed from about 28 to about 31 gauge material (the American wire gauge) with an outside diameter of about 0.2 mm to about 0.4 mm, preferably about 28 gauge material with 0.361 mm outside diameter or about 31 gauge material with about 0.227 mm outside diameter to allow for access and delivery at or near the apex. The distal tip 16 has a structural wall support 50 having a tubular shape that extends between the distal end 26 of the lumen 14 and the unattached end 48 of the distal tip 16. The distal tip may include a braided portion, may be multiple layered, may be formed from a single material or a composite of materials, and combinations thereof. The distal tip 16 includes an electrically conductive material. The structural wall support 50 is formed of a metallic or polymeric material. Additionally, the structural wall support can be spray coated with a metallic coating, such as silver. The structural wall support or portions of the wall may be formed of a tubular, woven, ribbed, and/or braided configuration. The distal tip 16 may have a constant inside diameter throughout the length of the distal tip or the diameter may taper or be stepped down to reduce the inside diameter along the length of the tip to the unattached end 48. The distal tip 16 may be removably attached to the lumen 14. FIGS. 3A and 3B show the distal tip 16 having one or more portals 52 for pressure equilibrium and irrigation. Notably, portals along the lumen apply additional safety and supply energized irrigating fluid.

FIGS. 2-3 show the device 10 attached to a hand held device 54. The hand held device 54 is attached to the fixture piece 12 at the hand held connector 32. The hand held device 54 may include a variety of instruments, attachments and members to assist with the use of the fixture piece 12, supply fluids, electricity from a source to the fixture piece, and delivery of a variety of elements including fluids and various types of energy such as sonic, ultrasonic, electric, mechanical, thermal and light energy.

FIG. 3A shows a sonic or ultrasonic energy source 20 located within the hand held device 54 extending from the device 10 for delivery of sonic or ultrasonic energy to the root canal 61 of tooth 60. The sonic or ultrasonic energy source 20 is in communication with the irrigating fluid to provide energy to the irrigating fluid. The sonic or ultrasonic energy source 20 can be internal or external to the hand held device 54. Further, the sonic or ultrasonic energy source 20 can be removably attached or integrated into any one of the device 10, the fixture piece 12, or the hand held device 54. The sonic energy is transported by the irrigating fluid to the root canal. The sonic energy desirably delivers a frequency of less then about 20 kilohertz, or an ultrasonic frequency from about 20 kilohertz to about 60 kilohertz.

Additionally, FIG. 3A shows the fluid supply line 46 attached to the fixture piece 12 including a regulator 56 may incorporated into the fluid supply line 46 to assist with regulating the pressure, amount and velocity of the irrigating fluid supplied to the fixture piece 12. Regulator 56 can be any device as known in the art such as balloon reservoirs, electrical pressure sensitivity systems, mechanical systems, safety valves, and other safety devices.

A second electrode 58 is shown in FIG. 3A. The second electrode 58 may be exterior to the tooth 60 as shown in FIG. 3A to receive electrons from the electrically charged irrigating fluid 62 dispensed from the distal end of the distal tip. In the embodiment shown in FIG. 3A, the electrons are supplied to the irrigating fluid by the first electrode 18. In another embodiment (not shown), the electric field is completed by the first and second electrodes. The irrigating fluid 62 transports the electrons within the lumen and distal tip to the distal end. An electrical field 118 is created about the surrounding fluid and bio-matter about the apex, the tooth and received by the second electrode 58, as shown in FIG. 6.

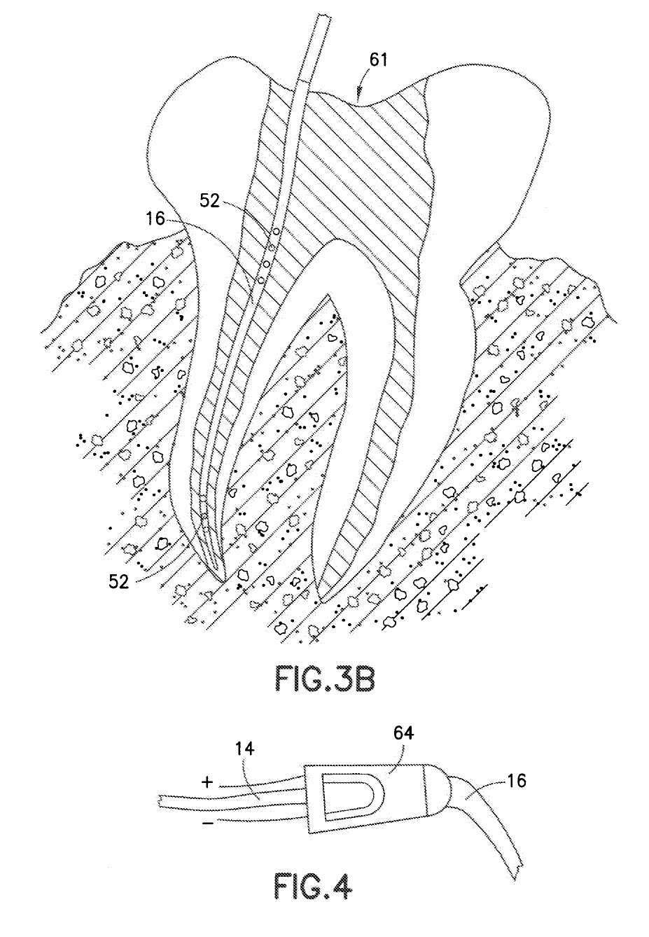

FIG. 4 shows an additional feature of a light element 64 which may be incorporated into the devices of the present invention, preferably attached to the exterior of the lumen 14 to illuminate the distal tip 16, interior of the tooth 60 and/or root canal by delivering light energy. The light element 64 may include any illumination device known in the art, such as an LED, ultraviolet light, or fiber optic devices. It is contemplated that the light element 64 may be integrally formed or removably attached to the lumen 14, fixture piece 12 and/or along the distal tip 14. Further, the light source may be incorporated within the lumen 14 to allow for light emission to travel through the fluid to be delivered at the distal tip 16.

FIGS. 5 and 6 show device 70, which is similar to device 10 of FIGS. 2-3, including fixture piece 80, lumen 74, distal tip 76 and first electrode 78. FIGS. 5 and 6 show fixture piece 80 integrated into a handheld device. The lumen 74 extends directly from one end 72 of the fixture piece 80, and distal tip 76 extends from lumen 74. The fixture piece 80 includes first electrode 78, sonic or ultra sonic energy source 84, chamber 66, mechanically operated plunger system 82, and an energy supply 88 for the electrodes. In the embodiment shown in FIGS. 5 and 5, a second electrode 86 extends from the fixture piece 80 for receiving electrons from the electrically charged irrigating fluid. In another embodiment (not shown), the electric field is completed by the first and second electrodes. FIG. 6 shows the electric field 118 created between the electrically charged irrigating fluid 62 and the second electrode 86 in the apex 63, root canal 61, and the tooth 60.

The first electrode 78 is internal to the fixture piece 80. The first electrode 78 is in communication with the lumen 74 at the proximal end 90. The first electrode 78 is configured to deliver electrical energy to an irrigating fluid 62 passing through proximal end 90 prior to discharge of the fluid from the distal tip 76.

FIGS. 5 and 6 show the sonic or ultrasonic energy source 84 being integrated into the fixture piece 80 for delivery of sonic or ultrasonic energy to the root canal. The sonic or ultrasonic energy source 84 can be detached, be present internal to the fixture piece or be located external to the fixture piece 80. FIG. 6 shows an outer larger tube for collection of irrigating fluid and may incorporate a second electrode.

The chamber 66 is located within the fixture piece 80 to receive a replaceable cartridge 68 containing the irrigating fluid 62 to supply the irrigating fluid 62 to the lumen 74. A mechanically operated plunger system 82 is in proximity to the chamber 66 to cause the replaceable cartridge 68 to release irrigating fluid 62. Various mechanically operated plunger systems may be used to force the irrigating fluid 62 in the replaceable cartridge 68 out to the lumen 74, i.e., by reducing the internal volume of the cartridge 68, or pressurizing the cartridge 68 by introducing air or another fluid into the cartridge 68 to force the irrigating fluid out to the lumen 74. FIGS. 5 and 6 show the mechanically operated plunger system 82 operable by a motor and gear shaft.

The replaceable cartridge 68 is shown as sealed, a small container to house the irrigating fluid 62. The cartridge 68 can be a single container, a divided container with multi-compartments each containing different fluids isolated on either side of the dividing wall(s), or a cartridge having a first fluid medium with an encapsulated second fluid dispensed therein The replaceable cartridge may include a mixer element to mix two fluids prior to the fluids entering the lumen 74. The mixing of fluids can also occur within the cartridge by breaking a dividing or by rupturing the encapsulated section of the cartridge to disperse the fluid within the first fluid medium. A mixing chamber may be incorporated into the cartridge or the fixture piece to allow for mixing of the fluids prior to entry into the lumen. This allows for unstable fluids mixtures/solutions or mixtures/solutions with short shelf lives to be mixed and/or activated prior to use.

An energy supply 88 for the electrodes is incorporated into the fixture piece 80 which supplies energy to the electrodes, and/or other elements of the device 70. Further contemplated is a mechanism 92 to integrate mechanical energy, sonic energy, and light energy to delivery to the root canal. Mechanical energy can be provided by the device 70 or fixture piece 80 which includes using up/down or lateral motion of the distal tip to agitate the fluid near the apex and/or provide of movement for accurate placement of the distal tip. The irrigating fluid can be pushed or pulled mechanically to provide movement of fluid to areas where the irrigating fluid would not normally enter.

FIG. 6 shows device 70 further including an apex locator 94 and a vacuum line 96. The apex locator 94 is located on and/or integrated with the fixture piece 80 to locate the apex of the root canal relative to the distal tip 76 of the device 70. The apex locator 94 is used to determine the position of the apex based on the specific resistance of the apex to electrical current, and thus determine the length of the root canal space. Additionally, a vacuum line 96 may be incorporated into the devices. FIG. 6 shows a multi-lumen 112 which includes lumen 74 for transporting the electrically charged irrigating fluid therethrough and a separate lumen 116 for the vacuum to utilize. The vacuum line 96 includes first end 98 and a second end 100. The vacuum line 96 is attached to the fixture piece 80. The first end 98 extends from the lumen 74 to provide a vacuum therethrough. The second end 100 is configured to connect a vacuum supply line thereto. The vacuum line evacuates the fluids and loose tissue or other material about the root canal, tooth, and/or apex and further may be used to provide a negative pressure environment thereabout.

The present invention further provides for a kit assembly. The kit assembly provides a fixture piece of any of the embodiments and a replaceable lumen, distal tip and first electrode. The kit assembly may also include a fixture piece 80 having a chamber 66, a lumen connector 110 and a sonic or ultrasonic energy source 84 for delivery of sonic or ultrasonic energy to the root canal; at least one replaceable portion 28 including a lumen 74, a distal tip 76 and a first electrode 78. The lumen 74 is removably attached to the lumen connector 110 of the fixture piece 80. At least one replaceable cartridge 68 of irrigating fluid is configured to be inserted into the chamber 66 to supply irrigating fluid to the lumen 74. Additionally, the kit may include a second electrode 58, 86 attachable to the fixture piece, and/or at least one replaceable receptor piece 114 attachable to the second electrode. The replaceable receptor piece 114 is attachable to a patient's body external to the tooth. The replaceable receptor piece 114 includes an electrode patch, pad, sticker, clamp, and other disposable receptor pieces as know in the art.

Furthermore, a method for treatment of a root canal in a tooth of the present invention includes the steps of providing a fixture piece having a sonic energy source, a lumen and a distal tip, as shown in FIGS. 1-6. The lumen has a proximal end extending from the fixture piece to a distal end extending from the distal tip. The proximal end may be external to the tooth and the distal tip is configured to deliver electrically charged irrigating fluid at or near the apex of the root canal. The sonic energy source is operative to introduce sonic energy to the root canal. The next step includes inserting the distal tip of the lumen into the root canal, and delivering the electrical energy, sonic energy and electrically charged irrigating fluid at or near apex of the root canal. The electrically charged irrigating fluid delivers the charge of electrons which is distributed about the apex, root canal and tooth by an electrical field. The distal tip may be moved by mechanical energy up/down and/or laterally and as the tip moves the electrical field changes in the area of and throughout the root canal.

It is contemplated that various elements and/or features as above-described may be combined to form various embodiments of the present invention which is within the scope of the invention. It will be appreciated that variations of the above-disclosed and other features and functions, or alternatives thereof, may be desirably combined into many other different systems or applications. It will also be appreciated that various presently unforeseen or unanticipated alternatives, modifications, variations, or improvements therein may be subsequently made by those skilled in the art which are also intended to be encompassed by the disclosed embodiments and the following claims.

What is claimed is:

1) A device for treating a root canal in a tooth comprising:
a fixture piece having a lumen and a distal tip, said lumen having a proximal end extending from said fixture piece to a distal end extending from said distal tip, said distal tip being configured to deliver electrically charged irrigating fluid at or near the apex of said root canal;
a first electrode in communication with said proximal end of said lumen, said first electrode being configured to deliver electrical energy to an irrigating fluid passing through said proximal end prior to discharge from said distal tip; and
a sonic or ultrasonic energy source from said fixture piece for delivery of sonic or ultrasonic energy to said root canal.

2) The device of claim 1, wherein said distal tip includes a microcannula portion.

3) The device of claim 2, wherein said distal tip is removably attached.

4) The device of claim 2, further comprising one or more portals located in at least one of the proximal end and the distal tip.

5) The device of claim 2, wherein said distal tip includes an electrically conductive material.

6) The device of claim 4, wherein said distal tip further includes a metallic or polymeric structural wall support.

7) The device of claim 6, wherein said structural wall support is a braided metal.

8) The device of claim 1, wherein said distal tip is flexible but sufficiently rigid to be manipulated at or near a terminus of the apex of the root canal.

9) The device of claim 1, wherein said irrigating fluid comprises an antiseptic agent.

10) The device of claim 1, wherein said irrigating fluid comprises an electrically conductive fluid.

11) The device of claim 1, wherein said irrigating fluid comprises at least one surfactant.

12) The device of claim 1, further comprising a mechanical energy source for delivery to said root canal.

13) The device of claim 1, further comprising a chamber within said fixture piece to receive a replaceable cartridge containing said irrigating fluid to supply said irrigating fluid to said lumen.

14) The device of claim 13, further comprising a mechanically operated plunger system in proximity to said chamber to release irrigating fluid from said replaceable cartridge.

15) The device of claim 1, further comprising a light source for delivery to said root canal.

16) The device of claim 1, further comprising a mechanism to integrate mechanical energy, sonic energy, and light energy to delivery to said root canal.

17) The device of claim 1, wherein said fixture piece is configured to be hand-held.

18) The device of claim 1, further comprising a vacuum line to evacuate the area about the root canal forming negative pressure about the root canal.

19) The device of claim 1, wherein said distal tip includes a microcannula portion, one or more portals for pressure release, and an electrically conductive material; said device further includes an additional energy source for delivery to said root canal; and said irrigating fluid is an antiseptic agent.

20) The device of claim 1, further comprising a second electrode external to the tooth.

21) The device of claim 1, further comprising an apex locator on said fixture piece.

22) The device of claim 1, wherein electrical energy flowing through said first electrode is about 0.0001 amps to about 1.0 amps and from about 0.001 volts to about 500 volts.

23) The device of claim 1, further comprising a supply line to deliver irrigating fluid to said fixture piece, said supply line including a regulator of said irrigating fluid to assist the regulation of the amount or velocity of said irrigating fluid to said device.

24) The device of claim 2, wherein said distal tip includes a non-conductive material.

25) The device of claim 4, wherein the irrigating fluid is under positive pressure.

26) The device of claim 4, wherein the irrigating fluid is under negative pressure.

27) A device for treating a root canal in a tooth comprising:
a fixture piece having a chamber, lumen and a distal tip, said lumen having a proximal end extending from said fixture piece to a distal end extending from said distal tip, said distal tip being configured to deliver electrically charged irrigating fluid at or near the apex of said root canal;
a first electrode in communication with said lumen about said proximal end, said first electrode being configured to deliver electrical energy to an irrigating fluid passing through said proximal end prior to discharge from said distal tip;
a second electrode exterior to said tooth to complete an electric field;
a sonic or ultrasonic energy source from said fixture piece for delivery of sonic or ultrasonic energy to said root canal;
a replaceable cartridge of irrigating fluid within said chamber to supply irrigating fluid to said lumen; and
a plunger system being integrated with said fixture piece to mechanically force said irrigating fluid out of said replaceable cartridge into said lumen.

28) The device of claim 27, further comprising a vacuum line including a first end and a second end, said vacuum line being attached to said fixture piece, said first end extends from said lumen to provide a vacuum therethrough, said second end being configured to connect a vacuum supply line thereto.

29) The device of claim 27, further comprising one or more portals located in at least one of the proximal end and the distal tip.

30) The device of claim 29, wherein the irrigating fluid is under positive pressure.

31) The device of claim 29, wherein the irrigating fluid is under negative pressure.

32) The device of claim 1, further comprising an apex locator integrated with said fixture piece to locate the apex of the root canal relative to the distal tip of the device.

33) A kit assembly for treating a root canal in a tooth comprising:
a fixture piece having a chamber, a lumen connector and a sonic or ultrasonic energy source for delivery of sonic or ultrasonic energy to said root canal;
at least one replaceable portion comprising a lumen, a distal tip and a first electrode, said lumen having a proximal end and a distal end, said proximal end removably attached to said lumen connector of said fixture piece, said distal tip extending from said distal end of said lumen, said distal tip being configured to deliver electrically charged irrigating fluid at or near the apex of said root canal, said first electrode in communication with said lumen about said proximal end, said first electrode being configured to deliver electrical energy to an irrigating fluid passing through said proximal end prior to discharge from said distal tip; and
at least one replaceable cartridge of irrigating fluid configured to be inserted into said chamber to supply irrigating fluid to said lumen.

34) The kit assembly of claim 33, further including a second electrode attachable to said fixture piece and external to said tooth, and at least one replaceable receptor piece attachable to said second electrode, said at least one replaceable receptor piece being attachable to a patient external to said tooth.

35) The kit assembly of claim 34, wherein said at least one replaceable receptor piece is an electrode patch.

36) The kit assembly of claim 33, further comprising one or more portals located in at least one of the proximal end and the distal tip.

37) The kit assembly of claim 29, wherein the irrigating fluid is under positive pressure.

38) The kit assembly of claim 29, wherein the irrigating fluid is under negative pressure.

39) A method for treatment of a root canal in a tooth comprising:
providing a fixture piece having a sonic energy source, a lumen and a distal tip, said lumen having a proximal end extending from said fixture piece to a distal end extending from said distal tip, said distal tip being configured to deliver electrically charged irrigating fluid at or near the apex of said root canal, said sonic energy source operative to introduce sonic energy to said root canal;
inserting said distal tip of said lumen into said root canal; and
delivering said electrical energy, sonic energy and electrically charged irrigating fluid at or near apex of said root canal.

40) The method of claim 39, further comprising one or more portals located in at least one of the proximal end and the distal tip.

41) The method of claim 39, wherein the irrigating fluid is under positive pressure.

42) The method of claim 39, wherein the irrigating fluid is under negative pressure.
